(19) United States
(12) Patent Application Publication
(10) Pub. No.: US 2021/0284848 A1
(43) Pub. Date: Sep. 16, 2021

(54) HIGH TEMPERATURE METALLIC SILICATE COATING

(71) Applicant: SHIELD TECHNOLOGIES, LLC, Palm City, FL (US)

(72) Inventor: A. Keith Campbell, Jupiter, FL (US)

(21) Appl. No.: 17/203,593

(22) Filed: Mar. 16, 2021

Related U.S. Application Data
(60) Provisional application No. 62/990,195, filed on Mar. 16, 2020.
(60) Provisional application No. 63/090,922, filed on Oct. 13, 2020.

(51) Int. Cl. C09D 5/18; C09D 7/61; C09D 163/00

(52) U.S. Cl. CPC C09D 5/18; C08K 3/34; C09D 163/00; C09D 7/61

(57) ABSTRACT

The invention involves a material that exhibits both thermal insulation and temperature resistance properties. The high temperature material is a metallic silicate bonded with a ceramic. The metallic silicate material mixes and applies with paint or paint base and provides temperature resistant color, as well as heat insulation to the object being coated. The metallic silicate also provides corrosion resistance to the base material. The metallic silicate preferably includes naturally occurring stone having a content of silicate and metal including metal ions. The silicate is converted to a liquid and bonded with a metal ion and, in some embodiments, a ceramic within a basic paint base to create the metallic silicate compound. The metallic silicate compound can be combined with or formed within a paint base and applied as a film or paint coating having high temperature resistance, heat reflectivity, and corrosion resistance.

### RELATED APPLICATIONS

This application claims benefit of priority of U.S. Provisional Patent Application No. 62/990,195, entitled “High Temperature Metallic Silicate Coating” and filed Mar. 16, 2020, this application also claims benefit of priority of U.S. Provisional Patent Application No. 63/090,922, entitled “High Temperature Metallic Silicate Coating” filed Oct. 13, 2020, the contents of which are incorporated herein.

### FIELD OF INVENTION

The present invention generally relates to coatings and solids; and more particularly, to a high temperature, highly heat resistant paint coating or solid, suitable for building materials and precursors such as liquids used to form the coatings and solids.

### BACKGROUND INFORMATION

Coatings for metals and the like that are subjected to high temperatures have been around for many years. Unfortunately, manufacturing a high temperature coating that does not deteriorate and or fail when subjected to elevated temperatures for extended periods of time has proven elusive. Modern high temperature coatings, such as paints, have a maximum temperature rating of 1200-1400 degrees Fahrenheit. When subjected to the maximum rated temperature, the paint coating deteriorates very quickly, losing original color and coating thickness. Many of the current coatings may also crack and peel when allowed to cool after being subjected to the elevated temperature.

Thus, what is needed in the art is a paint type coating that is suitable for use in elevated temperatures and environments, e.g. higher than 1400° Fahrenheit, for extended periods of time without detrimental deterioration.

There is also a need in the art for building materials that are highly resistant to heat or fire. Such materials should be formable into building materials such as siding, wall board, roofing materials and the like and additionally the formation of three dimensional objects. The metallic silicate coating should be moldable or have the capability to be added to preexisting raw building materials to add heat and/or fire resistance. The building materials may be resins, such as those used for injection, vacuum, extrusion or compression molding. The metallic silicate additive should also be usable for resins and other building materials that are mixed and used in the field, such as fiberglass resins and two part epoxies, polyurethanes, methacrylates, and the like. The material should be easily workable with pre-existing power tools, and should not be detrimental to the overall functionality of the base material.

Finally, there are needs that a high temperature coating material should satisfy in order to achieve acceptance by the end user. The coating should be easily and quickly applied using existing paint application hardware and a reduced number or no modifications of tools and equipment. Further, the coating should not call for special breathing apparatus (in addition to those already in use) or include highly toxic additives. Moreover, the high temperature coating components should assemble together in such a way so as not to need additional or more specialized equipment for combining and mixing the components of the coating.

Thus, the present invention in one embodiment provides a high temperature metallic silicate based material suitable for mixing with coatings and paint bases to create a high temperature coating which overcomes the disadvantages of prior art high temperature coatings and paints. The high temperature metallic silicate paint system of the present invention not only provides for relative ease in the mixing and implementation with current manufacturing equipment, it also permits application without the need for specialized equipment beyond those that are already in use for paint application. The present invention also provides a high temperature metallic silicate based paint that provides a suitable surface finish for use as applied and has acceptable thickness and adhesion. The material of the present invention may be added and mixed with the base paint material at the factory or in the field as a powder or wet slurry with the base material. The rheology of the mixture of metallic silicate and reactant can also be adjusted to form three dimensional objects. Alternatively, the metallic silicate material may be formed into solids that are molded, machined or otherwise shaped prior to use. Additional shaping, cutting, drilling or the like can be carried out in the field.

### SUMMARY OF THE INVENTION

Briefly, the invention involves a material that exhibits thermal insulation, fire resistance and temperature resistance properties. The following is based on a theory of operation and this theory is not binding on applicant. The high temperature material is a (comminuted or particulate) metallic silicate preferably with the particles being mixed with a reactant such as a silane to form a liquid or semi solid material that can be bonded with a polymer and/or with a ceramic and in some cases bonds to the polymer in which it is applied. The metallic silicate material mixes and applies with paint or paint base and provides temperature resistant color and fire resistance, as well as heat insulation to the object being coated that surprisingly survive temperatures in excess of break down temperatures of contained polymers. The metallic silicate also unexpectedly provides corrosion resistance to a coated base metal material in addition to the color. The metallic silicate preferably includes naturally occurring stone having a content of silicate and metal including metal ions. At least a portion of the silica or silicate is softened or converted to a liquid or semisolid and bonded with a metal and, in some embodiments a ceramic within a paint base that preferably contains some silane and/or some content of solvent, to create the metallic silicate compound. The metallic silicate based mixture can be combined with or formed within a paint base and applied as a film or paint coating having high temperature resistance, heat reflectivity, fire resistance and corrosion resistance to protect the material under the metallic silicate compound. In addition, the metallic silicate material may be added to or with polymers and resins known in the art to raise temperature and/or fire resistance without detrimentally affecting the base polymer or resin material. Such materials may include, but should not be limited to, resins, polymers, epoxies, polyurethanes, methacrylates, plastics, phenolics, and the like.

Accordingly, it is an objective of the present invention to provide a high temperature metallic silicate based material containing coating, semi-solid or solid material.

It is a further objective of the present invention to provide a metallic silicate and ceramic high temperature containing coating.

It is yet a further objective of the present invention to provide a high temperature metallic silicate based coating that can be utilized on a substrate material to increase the substrate's resistance to heat and fire.

It is another objective of the present invention to provide a high temperature metallic silicate based material that can be mixed at least with a polymer or resin base.

It is yet another objective of the present invention to provide a metallic silicate based material that can be formed using a paint base.

Other objectives and advantages of this invention will become apparent from the following description taken in conjunction with the accompanying drawings wherein are set forth, by way of illustration and example, certain embodiments of this invention. The drawings constitute a part of this specification, include exemplary embodiments of the present invention, and illustrate various objects and features thereof.

### BRIEF DESCRIPTION OF THE FIGURES

FIGS. 1A-1C are a report illustrating testing for the present metallic silicate based material mixed with a known paint material;

FIG. 2 is a report illustrating a comparison of the thermal properties of the metallic silicate based material and other high temperature coating products on the market;

FIGS. 3A-3B are a report illustrating testing for the present metallic silicate based material mixed with a known commercial paint material;

FIG. 4 is a perspective view illustrating the metallic silicate based material on a surface;

FIG. 5 is a perspective view illustrating the metallic silicate based material in a layered structure; and

FIG. 6 is a perspective view of a three dimensional object formed from the metallic silicate based material.

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

In its simple form, the invention involves the production of metallic silicate based material that is reacted with a solubilizing compound to produce a reaction product cohesive mass that can be either in liquid like a paint or semi solid form that can be molded as by casting or pressure forming. The metallic silicate is preferably a naturally occurring material that is in particulate form, say 20 mesh or finer. Such metallic silicate can include basalt, olivine and granite or other rock materials including at least twenty five percent silica. The solubilizing compound can be a silane like glycidoxypropyltrimethoxysilane or methacryloxypropyltrimethoxysilane or other silanes that contain two types of reactivity, inorganic and organic, in the same molecule. The produced rheology can be liquid or semi solids and can be adjusted by the amount of solubilizing compound relative to the amount of metallic silicate and other ingredients in the final product such as polymers like epoxy, ceramic particles and the like. A base such a sodium bicarbonate can also be added to adjust the properties of the final end product and aid in the formation of grain structure.

Referring generally to the disclosure, a high temperature metallic silicate based material for mixture into a paint (containing a paint base), a paint base or a polymer or resin to create a high temperature coating or material is disclosed. The high temperature coating or material exhibits both thermal insulation and fire resistance properties. In general, a metallic silicate material, for example basalt, is at least partially liquefied or softened, preferably by reaction with a liquid, like a paint base having solvents and/or a silane in a liquid form that reacts with the silica in the basalt to cause the liquefaction or softening of at least a portion of the silica in the basalt. The liquefied or softened silica in the basalt is preferably combined with a ceramic material in the form of small granules, pellets or spheres. The basalt combines and/or bonds with the metal contained naturally in the basalt, particularly when activated with a silane, and a portion of the ceramic to form a liquid or slurry that is readily mixable with most enamel or alkyd resin based paints. The metallic silicon based material can also be mixed as a powder, slurry or liquid with epoxies, polyurethanes, methacrylates, plastics, phenolics and the like without detrimentally affecting the structural properties of these materials. In some instances, the metallic silica based material should be pre-reacted into a slurry or liquid by placing at least the basalt and in some cases the basalt and the ceramic into a suitable base material such as, but not limited to, glycidoxypropyltrimethoxysilane sold by DOW chemical under the trademark SILANE, having a CAS chemical number 2530-83-8. Other Silanes having an alkoxy group and organo-functional group such as methacryloxypropyltrimethoxysilane may also be used without departing from the scope of the invention. In general, the silane coupling agents are silicon based chemicals that contain two types of reactivity, inorganic and organic, in the same molecule. A typical general structure is Y—Si(OR)sub 3 where OR is a hydrolyzable group such as amino, methacryloxy, epoxy, etc. A silane coupling agent will act as a link between an inorganic substrate and an organic material to bond or couple the two dissimilar materials together. It has been found that this Silane material, which is often incorporated into paints and other resins as a portion of the “base”, is suitable to create a liquefaction or reaction of at least a portion of the silica in the basalt to cause the silica to bond with the metals in the basalt as well as the polymer. The basalt and ceramic may thus be blended with a paint or resin base as a powder or as a pre-reaction product that can be added to materials not containing base chemicals suitable to liquefy a portion of the basalt and generate the reaction. The pre-reaction slurry can, and has been, successfully added to materials such as water based paints to add significant heat and fire resistance to the resulting coating. In this reaction, the silane is preferably mixed with an alcohol such as ethanol and the Ph. Is reduced to about five. Therefter, the silane and alcohol is added to the powdered basalt or other stone to be wetted and thereafter added to the water based coating. The metallic silicate material can be added to water based paints without the reduction in ph. However, when this done, the metallic silicate material recrystallizes into very fine particles or micro-particles when coming into contact with the water, allowing the particles to flow freely when applied and not affecting the surface finish of the paint or other coating or solid material.

As used herein, enamel paint is paint that dries to a hard, usually glossy finish used for coating surfaces that are outdoors or otherwise subject to hard wear or variations in temperature; it should not be confused with decorated objects in “painted enamel”, where vitreous enamel is applied with brushes and fired in a kiln. Typically, the term “enamel paint” is used to describe oil-based covering products, usually with a significant amount of gloss in them. The term is typically understood to mean “hard surfaced paint” and usually is in reference to paint brands of higher quality, floor coatings of a high gloss finish, or spray paints. Most enamel paints are alkyd resin based. Some enamel paints have been made by adding varnish to oil-based paint. Enamel paints can also refer to nitro-cellulose based paints, one of the first modern commercial paints of the 20th century. They have since been superseded by new synthetic coatings like alkyd, acrylic and vinyl, due to toxicity, safety, and conservation (tendency to age yellow) concerns. Pyroxyline paint is a DuPont brand name for a tough and resilient type of nitro-cellulose paint manufactured for the automotive industry. Nitro-cellulose enamels are also commonly known as modern lacquers.

The viscosity rheology of the liquefied, partially liquefied, or softened metallic silicate material can be further adjusted with the proper solvent or paint thinner for the paint or solid base for a desired use of the material, for example, spraying, rolling, brushing, dipping, forming and the like. The generally low viscosity of the metallic silica mixture allows the high temperature mixture to be applied as a thin paint like layer of material on a substrate. Alternatively, the metallic silicate based material may be added to epoxies, resins or the like to form solids that can be added to substrates or used alone. Substrates can include, but are not limited to, lignocellulosic materials such as OSB, plywood, dimensional lumber particle board, fiberboard (such as MDF) and the like. As used herein, metallic material substrates include both metal alloys and elemental metals. Unless otherwise specifically designated, the term metal includes both elemental metal (including impurities) and metal alloys. The material can also be applied to polymeric materials, such as fiber reinforced plastics and the like. Higher viscosity materials can be used for molding, such as casting or pressure forming, to form three dimensional objects constructed from the metallic silicate material. Such materials may be used for fire doors, fire panels, boat hulls, automotive products or the like.

It has been discovered that many paints contain a material that is similar to or has a similar liquefying effect on the silicate in the basalt as the 3-glycidoxypropyltrimethoxysilane or 3-methacryloxypropyltrimethoxysilane. If the paint contains enough Silane based material of sufficient strength, the metallic silicate material may be mixed with the paint or paint base as a powder to effect liquefaction and/or adherence of at least a portion of the silicate material (e.g., basalt) or other high metallic silicate material. It is to be understood that the silicate material can be liquified separately with a material, such as glycidoxypropyltrimethoxysilane, sodium hydroxide or sodium sulfate and activated carbon with a non-water based solvent, and thereafter added to a water based paint or other resin or polymeric material.

Additional materials can be added to the liquified materials to provide custom properties depending on the method used to form the material for its final use. For low viscosity use, an adherent can be added, such as a paint adherent that helps the material adhere like paint to an object to be coated. Such adherents include, but should not be limited to, a bifunctional silane containing a glycidoxy reactive organic group and a trimethoxysilyl inorganic group. For enhanced thermal insulating properties, ceramic material can be added, like boron ceramics, cordierite, HY-TECH THERMACELS sold by Hy-tech thermal solutions of Melbourne, Fla., or another ceramic or clay material in a powder, granular or spherical form. The term cordierite includes materials based on cordierite with various additives. Cordierite (Mg₂Al₄Si₅O₁₈) is magnesium silicate with a tetrahedral framework structure.

According to the classification of silicates, cordierite belongs to the class of silicates and subclass of cyclosilicates. Cordierites containing the hexagonal and orthorhombic magnesium/aluminosilicate frameworks consist of tetrahedral units [(Si/Al)O₄], forming Si₆O₁₈ six-membered rings. The rings are stacked one above the other and successively rotated about 30° relatively to each other. These rings are linked together laterally and vertically by tetrahedral and [MgO₆] octahedral. The ring stacking produces large hexagonal channels parallel to the c-axis, in which various cations or small molecular units can be inserted. Some suitable boron ceramics are listed in U.S. Pat. No. 4,987,201, the contents of which are incorporated herein by reference. It has been found that these ceramics can be suitably combined with the metallic silicate material to achieve high heat resistance. When added, a small portion of the ceramic may liquefy as part of the basalt reaction to the Silane material; however, at least a portion of the ceramic remains solid in the mix, whether pre-mixed as a slurry or formed within the paint or other polymer. It should be noted that other ceramics are suitable for use with the present material so long as they have a content of silica, silicone or silicon that will at least partially react with the liquefaction of the silicate in the basalt.

In a preferred embodiment, basalt is used as the metallic silicate. Granite is also a metallic silicate, as is Olivine. Basalt, Olivine and granite are naturally occurring metallic silicates. Basalt is described as a mafic extrusive igneous rock formed from the rapid cooling of magnesium-rich and iron-rich lava exposed at or very near the surface of a terrestrial planet or a moon. More than 90% of all volcanic rock on Earth is basalt. By definition, basalt is an aphanitic (fine-grained) igneous rock with generally 45-53% silica (SiO₂) and less than 10% feldspathoid by volume, and where at least 65% of the rock is feldspar in the form of plagioclase. This is as per definition of the International Union of Geological Sciences (IUGS) classification scheme. It is the most common volcanic rock type on Earth, being a key component of oceanic crust, as well as the principal volcanic rock in many mid-oceanic islands, including Iceland, the Faroe Islands, Reunion and the islands of Hawaii. Basalt commonly features a very fine-grained or glassy matrix interspersed with visible mineral grains. The average density is reported to be 3.0 g/cm³. Basalt is characterized by its mineral content and texture, and physical descriptions without mineralogical context may be unreliable in some circumstances. Basalt is usually grey to black in color, but rapidly weathers to brown or rust-red due to oxidation of its mafic (iron-rich) minerals into hematite and other iron oxides and hydroxides. Although usually characterized as “dark”, basaltic rocks exhibit a wide range of shading due to regional geochemical processes. Due to weathering or high concentrations of plagioclase, some basalts can be quite light-colored, superficially resembling andesite to untrained eyes. Basalt has a fine-grained mineral texture due to the molten rock cooling too quickly for large mineral crystals to grow; it is often porphyritic, containing larger crystals (phenocrysts) formed prior to the extrusion that brought the magma to the surface, embedded in a finer-grained matrix. These phenocrysts usually are of olivine or a calcium-rich plagioclase, which have the highest melting temperatures of the typical minerals that can crystallize from the melt. Preferably, the basalt starting material is in particulate form as by comminution; for example, the majority of the basalt having mesh size less than about a 20 mesh, and more preferably a 200 mesh. However, it should be noted that smaller mesh sizes facilitate faster liquefaction of the basalt in the base, and it may be possible to use larger sizes with increased reaction times.

Granite is another metallic silicate material. Granite is a common type of felsic intrusive igneous rock that is granular and phaneritic in texture. Granites can be predominantly white, pink, or gray in color, depending on their mineralogy. The word “granite” comes from the Latin granum, a grain, in reference to the coarse-grained structure of such a holocrystalline rock. Strictly speaking, granite is an igneous rock with between 20% and 60% quartz by volume, and at least 35% of the total feldspar, consisting of alkali feldspar, although commonly the term “granite” is used to refer to a wider range of coarse-grained igneous rocks containing quartz and feldspar. The term “granitic” means granite-like, and is applied to granite and a group of intrusive igneous rocks with similar textures and slight variations in composition and origin. These rocks mainly consist of feldspar, quartz, mica, and amphibole minerals, which form an interlocking, somewhat equigranular matrix of feldspar and quartz with scattered, darker biotite mica and amphibole (often hornblende) peppering the lighter color minerals. Occasionally, some individual crystals (phenocrysts) are larger, in which case the texture is known as porphyritic. A granitic rock with a porphyritic texture is known as a granite porphyry. Granitoid is a general, descriptive field term for lighter-colored, coarse-grained igneous rocks. Petrographic examination is required for identification of specific types of granitoids. The extrusive igneous rock equivalent of granite is rhyolite.

A suitable base, such as 3-glycidoxypropyltrimethoxysilane, 3-methacryloxypropyltrimethoxysilane, a combination of sodium sulfate and activated charcoal is added to a particulate metallic silicate such as basalt. One or more suitable, substantially water free solvents, which may be selected from a group including oxygenated, halogenated and hydrocarbon, including lacquer thinner, acetone, enamel reducer, 2-butoxyethanol, ethanol, methanol, butyl acetate, dimethyl carbonate, isobutanol, propylene glycol methyl ether acetate (PGMEA, 1-methoxy-2-propanol acetate) or a paint base, a suitable combination thereof or the like, is added. The mixture is preferably accomplished without the addition of water, or use of a water based solvent, to allow mixture into a non-water-based paint. A chemical reaction occurs, and the reacted metallic silicate like basalt becomes partially liquid or softened. When a ceramic that includes silica or silicate is included in the mix, at least a portion of the ceramic also may become liquid or suitably softened to bond with the silicate, while a portion of the ceramic preferably does not liquefy. In this arrangement, it is believed that the grain structure of the metallic silicate is influenced by the grain structure of the ceramic during the hardening of the coating for use. Ca++, Al+++, or Mg++, boron or other suitable ions may be included in the silicate stone material for bonding with the silicate. Other metals or metal compounds, such as mixtures of copper, nickel, manganese ferrite, chromium and stainless steel powder may be naturally occurring in the stone or added to the mixture and bonded to the metallic silicate material for added heat resistance. Sodium bicarbonate and the like may be added to the mixture including the paint base to aid in gelling and/or crystal reformation during the drying or hardening process. A micronized synthetic amorphous silica-gel, such as Fugi SY446, may be added to the paint base. Materials such as Nacure 155 may also be added to the paint base. Nacure is a hydrophobic sulfonic acid catalyst based on dinonylnaphthalene disulfonic acid supplied as a 55% concentrate in isobutanol. Its primary use is as a catalyst for promoting the cure of hydroxy, carboxy and amide functional polymers with melamine and urea-formaldehyde crosslinking agents, such as a hexa(methoxymethyl) melamine-formaldehyde (MF) resin. It is available as 98% solvent-free. Such a chemical known in the industry is Resimene® 747, which is stated to be used to formulate solvent and waterborne stoving enamel paints, automotive primers, base & clear coats, coil coatings and acid-cured coatings. Bentonite, synthetic bentonite, and other clays may be added to the paint base to add viscosity, and some may add additional heat resistance as they bond onto the metallic silicone material. Microcrystalline silica fillers and the like may also be added to the paint base.

Preferably, for a surface application material, a liquid adherent is added. Such an adhesive is known in the industry and sold under the name of Dow Corning® Z-6040 Silane. Dow silane is a bifunctional silane containing a glycidoxy reactive organic group and a trimethoxysilyl inorganic group. The adherent will help form a continuous liquid layer of the mixture and help the reacted basalt adhere to a substrate. The mixture hardens as a solid layer, like paint, on a substrate. Upon hardening, the material is generally homogenous throughout the coating or solid formed by the mixture.

For enhanced thermal insulation properties, it has been found that a ceramic material can be added to the metallic silicate based containing material. Such a material is preferably a ceramic material, such as cordierite, cordierite derivatives, Boron Silicates, as well as other ceramic materials that include silica or silicates. It is added in an amount of between about 10% and about 400% by weight of the metallic silicate material.

It has been found by experiment that, when both the adherent Silane and the ceramic material are used in combination with the metallic silicate based material, both improved fire resistant and thermal insulating properties are achieved. For example, independent testing at university laboratories tested the high temperature material sprayed and dried (hardened) onto a steel plate up to 3600 degrees Fahrenheit without failure or degradation of the coating. Fire resistance is particularly important on flammable substrates such as the lignocellulosic building materials described above, particularly when used in homes, commercial buildings, workplaces and the like. Thermal insulation is important in such areas to resist flammable materials, for a time, from reaching ignition temperatures. On non-flammable objects, at least at temperatures below extreme temperatures typically not encountered in structure fires, insulating properties are important to reduce heat failure of structural elements, such as high-rise building structural metal beams, oil & gas rigs, nuclear power plants, and military vessels such as ships, vehicles and weapons. The present invention provides both insulating properties and fire resistance properties. It can be used as a coating or formed into three dimensional objects. Its thermal insulating properties may be enhanced by the addition of ceramic particles.

The metallic silicate, particularly ground basalt, was added to Rust-oleum high temperature paint base and reacted with its base components to test the present invention. The standard paint will test up to 1400° F. for very short periods of time, e.g. seconds or minutes. Beyond a few seconds or minutes at temperatures over 1400° F., the material fails to retain color and fails to remain on the painted object. With the metallic silicate added at a level of 3% by volume of the original paint, the high temperature coating was utilized to coat panels at 2.5 mil dry film thickness (DFT) and allowed to harden for 8 hours at room temperature. The original paint and the paint with the metallic silicate were placed side by side in a 1400° F. oven for 8 hours without color change or failure of the modified paint. While the paint without the additive turned white and lost thickness and volume. In addition to the lack of color change, tests indicated a 20% increase in emissivity in which a surface emits thermal energy over the unmodified paint material. Cross hatch adhesion of the modified paint passed 100%; direct impact and indirect impact tests also indicated a 100% passage rate. The original paint turned white and thinned to the point of failure for use as a protective coating. It should be noted that the high temperature coating may be added to existing paint bases in different amounts, ranging from about 1% to at least about 50%, with positive results with respect to temperature tolerance and color retention.

These coatings not only increase temperature resistance and fire resistance, but also provide corrosion resistance. The modified paint can have its viscosity adjusted to provide more temperature resistance, i.e., the higher the viscosity as a result of utilizing more reacted metallic silicate. The metallic silicate material was tested by adding 2% total weight of the metallic silicate to a silicone high heat coating and reacted with a base. The silicone coating withstood 1200° F. in the standard form. With the reacted additive, it was able to withstand temperature in excess of 3500° F.

Paint material containing the reacted metallic silicate passed ASTM 5144. The modified paint material also passed Protective Coating Standards in Nuclear Power Plants, ASTM 3363 Film Hardness, ASTM 3359 Adhesion, ASTM 2794 Resistance to Rapid Deformation, and ASTM D-1654 Corrosive Environments. These tests were performed at independent testing facilities.

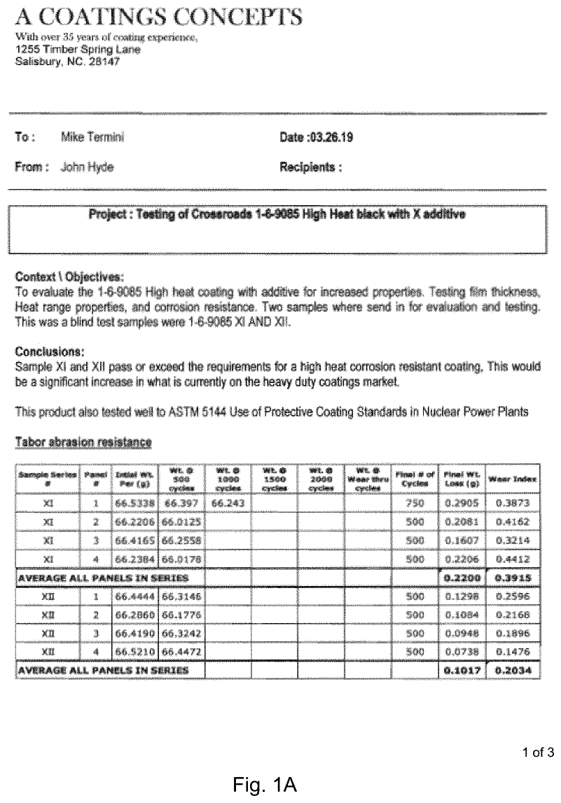

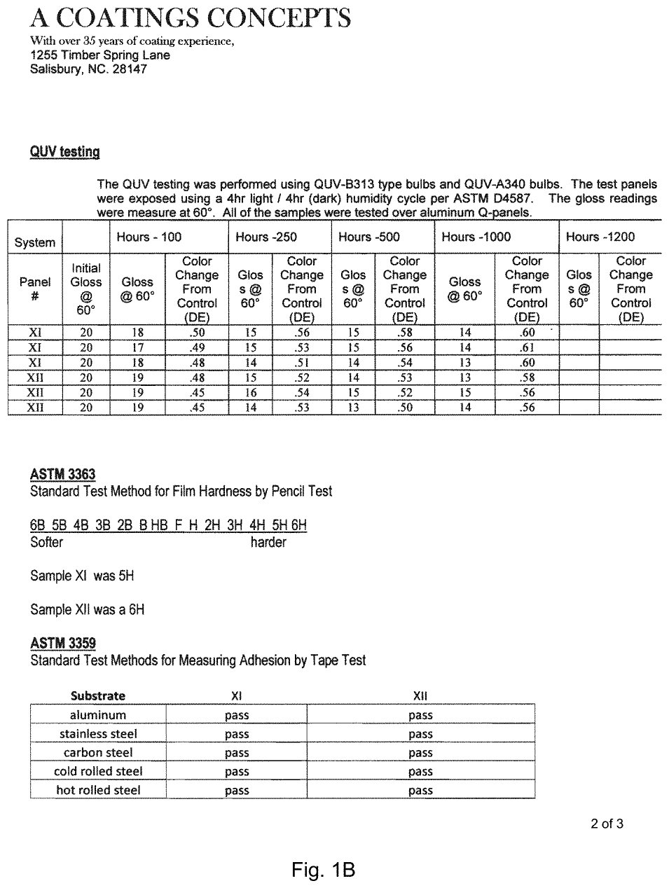

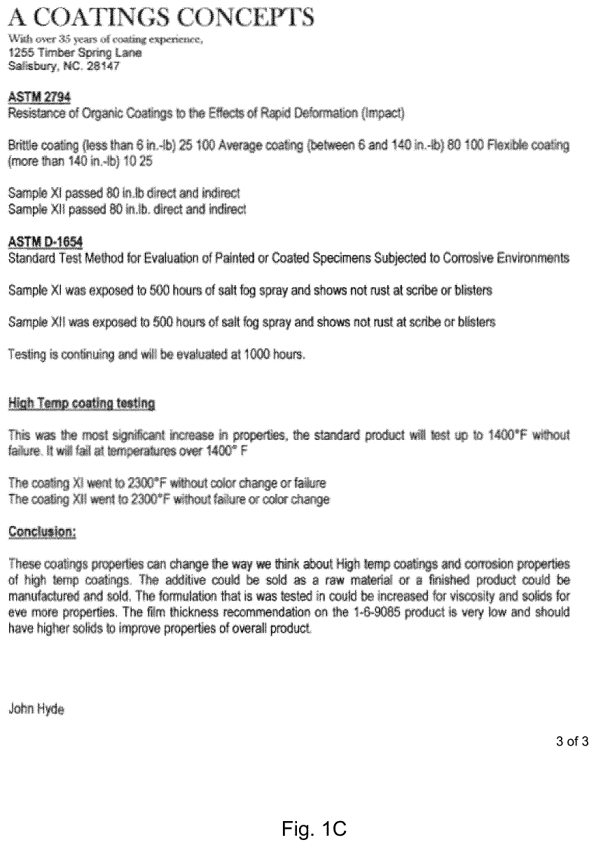

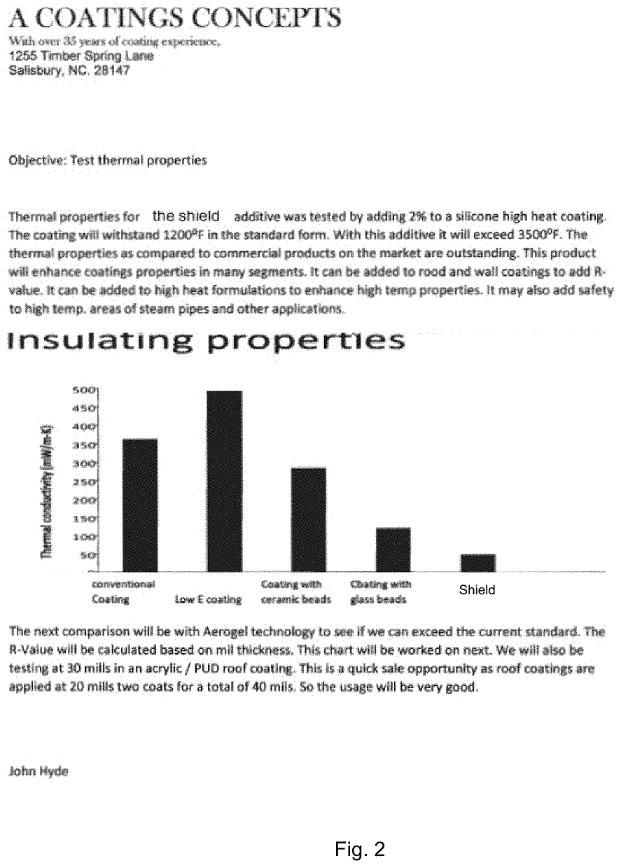

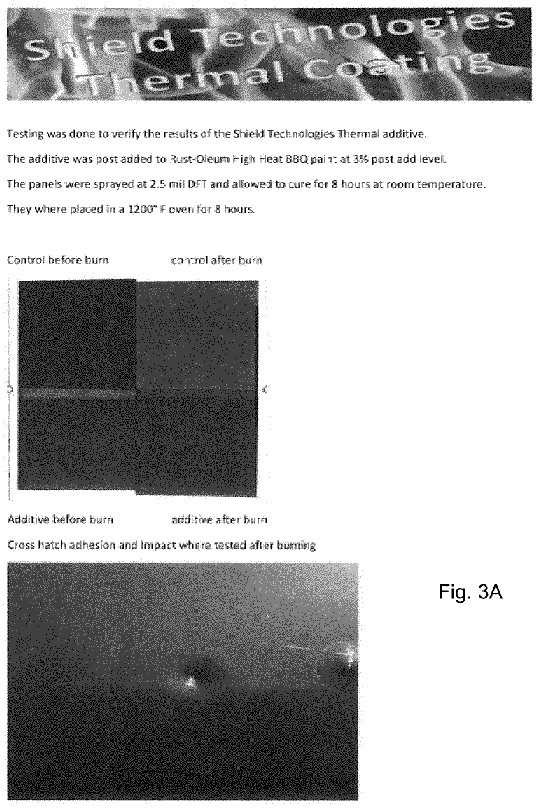

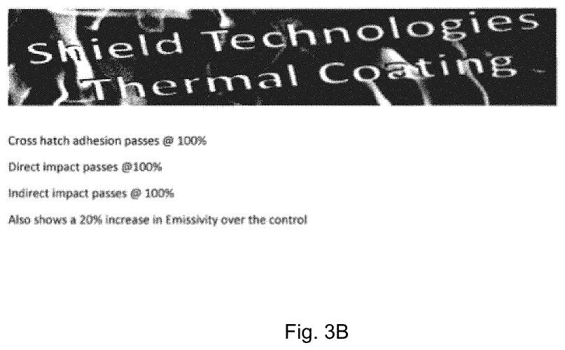

In one example, 2 ounces of cordierite, 1 ounce of ground basalt and 0.3 ounces of sodium bicarbonate were added to one quart of Crossroads™ 1-6-9085 high heat black premium paint. The material was applied as a liquid to a metal panel, cured and tested to 3600° Fahrenheit without failure. See FIGS. 1A-1C and FIG. 2 attached for copies of the reports. In another example, 3 ounces of cordierite, 1 ounce of ground basalt and 0.3 ounces of sodium bicarbonate were added to one quart of Rust-oleum high heat black. The material was tested for 8 hours at 1400° F. without failure. See FIGS. 3A and 3B attached hereto.

It should also be noted that the metallic silicate material can be mixed and poured or forced under pressure with an added polymer into molds for hardening. After hardening, the metallic silicate material can be removed from the molds for use as tiles, barriers or the like while still providing the heat and fire resistance.

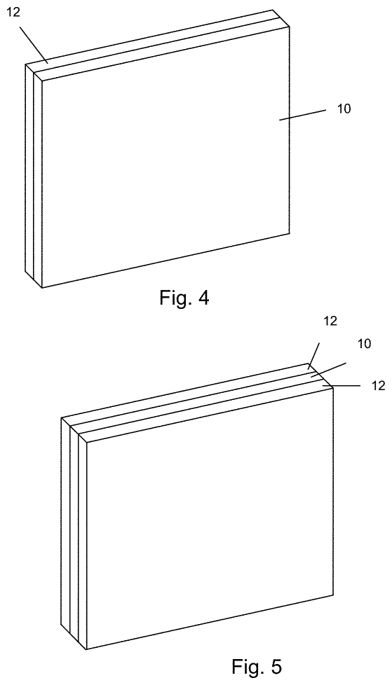

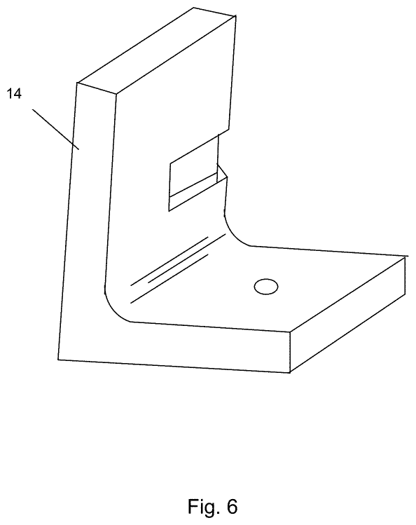

Referring to FIGS. 4-6, various embodiments of the present material are illustrated. FIG. 4 illustrates the metallic silicate material 10 on a substrate material 12. FIG. 5 illustrates the metallic silicate material 10 in a layered or laminated construction between two pieces of substrate material 12. FIG. 6 illustrates a three dimensional solid 14 formed from the metallic silicate material. The metallic silicate material can be added from one percent by total weight to eighty five percent by total weight, with remainder being made up of polymers.

It is to be understood that while certain forms of the invention are illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A mixture for making a heat resistant material including:
a comminuted metallic silicate having a mesh size of less than about 20 mesh;
a reactant including a silane binder, the silane binder being reactive with the metallic silicate to form a reactant material, the reactant material constructed and arranged to form both organic bonds and inorganic bonds when mixed with at least one other material.

2. The mixture of claim 1 wherein the at least one other material includes a polymer.

3. The mixture of claim 2 wherein the polymer is a paint.

4. The mixture of claim 1 wherein the silane is added as a liquid.

5. The mixture of claim 4 wherein the a reactant material is capable of allowing the silane binder and metallic silicate to form a reactant mixture that will form into one of a liquid and a semi solid for making a high temperature resistant object.

6. The mixture of claim 1 wherein the metallic silicate including basalt.

7. The mixture of claim 6 wherein the metallic silicate including olivine.

8. The mixture of claim 1 wherein the metallic silicate including olivine.

9. The mixture of claim 1 wherein the metallic silicate including granite.

10. The mixture of claim 6 including ceramic particles of less than about 100 mesh.

11. The mixture of claim 10 including sodium bicarbonate.

12. The mixture of claim 10 wherein the ceramic particles are boron ceramic.

13. The mixture of claim 12 wherein the boron ceramic particles are hollow spheres.

14. The mixture of claim 1 wherein the comminuted metallic silicate is a volcanic stone.

15. The mixture of claim 1 including powdered metal.
